(19) United States
(12) Patent Application Publication
(10) Pub. No.: US 2015/0373692 A1
(43) Pub. Date: Dec. 24, 2015

(54) Anonymous fingerprint generation for mobile communication device

(71) Applicant: Walkbase Ltd, Turku (FI)

(72) Inventors: Niclas Jern, Turku (FI); Björn Sjölund, Turku (FI)

(21) Appl. No.: 14/716,764

(22) Filed: May 19, 2015

Related U.S. Application Data
(60) Provisional application No. 62/014,530, filed on Jun. 19, 2014.

(51) Int. Cl. H04W 72/04; H04W 4/02; H04L 29/12

(52) U.S. Cl. CPC H04W 72/0413; H04L 61/6022; H04W 4/023

(57) ABSTRACT

A method for creating an electronic fingerprint for a mobile communication device, that includes receiving at a sensor, a first message from the mobile communication device, the first message comprising a mobile device identifier and a network identifier, sending to the server, a second message that comprises at least a part of the first message, and a sensor identifier, calculating a first fingerprint from the second message, and associating the first fingerprint with the a first unique identifier.

### TECHNICAL FIELD

The present disclosure generally relates to fingerprint generation for a mobile communication device, and more particularly to fingerprint generation for location based tracking of the mobile communication device.

### BACKGROUND

Location based tracking of mobile communication devices is generally employed for providing location based services to the users of the mobile communication devices. One such location tracking method includes using the mobile communication device's Medium Access Control (MAC) address acquired from the BSSID (Basic service set identification) field of the Wi-Fi probe request for visitor/customer tracking purposes. A Wi-Fi probe request is a standardized query format for seeking available wireless access points for connecting to a WLAN. The Wi-Fi probing mechanism described is a standardized feature in IEEE 802.11 group of standards.

However, location based tracking based on the MAC address may not always yield accurate results, since the mobile communication device may use a randomized MAC address when generating the Wi-Fi probe request. For example, Apple iOS 8 randomizes the MAC address when doing Wi-Fi probing to prevent tracking of devices.

On the other hand, using the MAC address also poses a privacy issue, since the MAC address is unique to each network interface, such as Wi-Fi. Indoor customer tracking systems may use a scrambled version of the MAC address for location based tracking.

Therefore, there is a need for a location based tracking system that enables location tracking of a mobile communication device, without necessarily using the MAC address as an identifier, and that overcomes the limitations of the existing location based tracking systems.

### SUMMARY

The present disclosure seeks to provide a computer-implemented method for creating an electronic fingerprint for a mobile communication device.

In one aspect, there is provided a method for creating an electronic fingerprint for a mobile communication device. The method includes receiving at a sensor, a first message from the mobile communication device, the first message comprising a mobile device identifier and a network identifier; sending to the server, a second message that comprises at least a part of the first message, and a sensor identifier; calculating a first fingerprint from the second message; and associating the first fingerprint with the a first unique identifier.

In an embodiment of the present disclosure, the method further includes comparing a similarity level of the first fingerprint and a second fingerprint, the second fingerprint having a second unique identifier stored in the server; associating the first fingerprint with the second unique identifier if the similarity level of the first fingerprint and the second fingerprint is at least above a predetermined threshold level; and associating the first fingerprint with the first unique identifier if the similarity level is below the predetermined threshold level.

In an embodiment of the present disclosure, the first and second unique identifiers are associated with a location of the mobile communication device.

In an embodiment of the present disclosure, the first message includes an IEEE 802.11 based probe request.

In an embodiment of the present disclosure, the sensor combines at least two first messages to form the second message.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an environment wherein various embodiments of the present disclosure can be practiced;

FIG. 2 is a schematic illustration of an exemplary sensor, in accordance with an embodiment of the present disclosure;

FIG. 3 is an illustration of an exemplary space visited by the user of the mobile communication device, in accordance with an embodiment of the present disclosure;

FIG. 4 is an illustration of the exemplary space including the first through fifth sensors, in accordance with an embodiment of the present disclosure;

FIG. 5 is an illustration of a exemplary Wi-Fi probe request generated by the mobile communication device, in accordance with an embodiment of the present disclosure;

FIG. 6 is an illustration of a method of processing probe packages at the server system, in accordance with an embodiment of the present disclsoure; and

FIG. 7 is an illustration of an exemplary UUID record, in accordance with an embodiment of the present disclosure.

### DETAILED DESCRIPTION

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

Embodiments of the present disclosure provide a computer-implemented method for creating an electronic fingerprint for a mobile communication device. The method includes receiving at a sensor, a first message from the mobile communication device, the first message comprising a mobile device identifier and a network identifier; sending to the server, a second message that comprises at least a part of the first message, and a sensor identifier; calculating a first fingerprint from the second message; and associating the first fingerprint with the a first unique identifier.

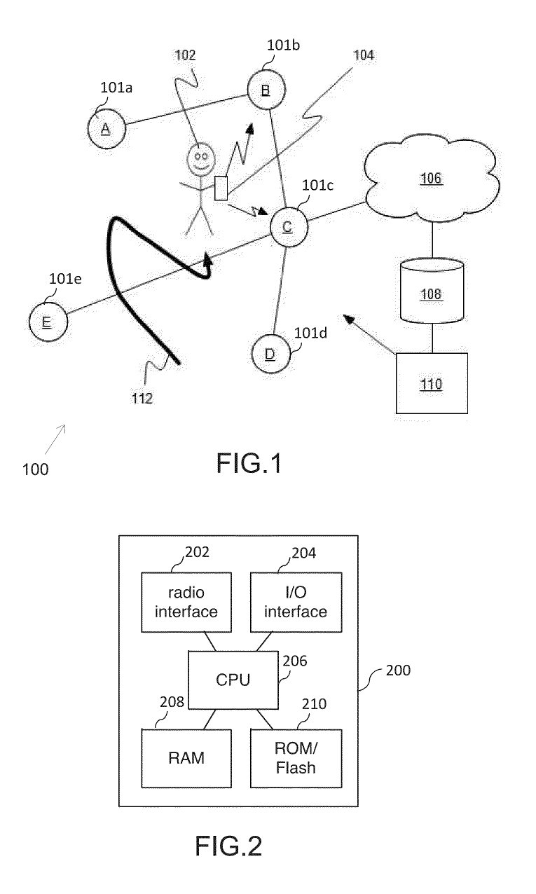

Referring now to drawings, more particularly by their reference numbers, FIG. 1 is a schematic illustration of an environment 100 wherein various embodiments of the present disclosure can be practiced. The environment 100 includes first through fifth sensors 101a till 101e (hereinafter collectively referred to as sensors 101) positioned in a space such as in a department store, mall, shop, sports arena etc, and are configured to receive radio signals from a mobile communication device 104 carried by a visitor 102 therein. Examples of the mobile communication device 104 include, but are not limited to, personal digital assistant, tablet, phablet, webpad, wearable computer, mobile telephone, wrist-worn computer, and smart phone. The radio signals from the mobile communication device 104 are for example, Wireless Local Area Network (WLAN) and/or Wi-Fi signals.

The sensors 101 are generally configured to scan the surrounding air to receive Wi-Fi probe requests from the mobile communication devices which have their Wi-Fi capability turned on. A Wi-Fi probe request is a standardized query format for seeking available wireless access points for connecting to a WLAN. The Wi-Fi probing mechanism described is a standardized feature in IEEE 802.11 group of standards. The mobile communication device 104 typically contain a list of previously used networks to facilitate re-joining previously visited networks. When searching for a WLAN to join in, the mobile communication device 104 sends Wi-Fi probe requests containing mobile devices own identifiers (Media Access Control (MAC) address) and the Service set identifier (SSID) of a WLAN. By listening to this wireless probe traffic, a sensor 101 can compose a list of “known network” of the mobile communication device 104.

The sensors 101 are further configured to communicate with each other in an ad-hoc manner to form an ad-hoc network to deliver information regarding signal strength, MAC address and SSID. At least one of the sensor 101, for example, the sensor 101c is connected to a communication network 106 through an ADSL connection or other wired or wireless means. Examples of the communication network 106, include, but are not limited to, Internet, Intranet, LAN, and WAN.

The sensor 101c is communicately coupled to a server system 108 through the communication network 106. Based on the information received from the sensors 101, the server system 108 calculates and records a movement path 112 of the visitor 102. The server system 108 further calculates a fingerprint for the mobile communication device 108 from the “known network list” and use it as an anonymous identifier for a user to enable visitor location tracking without harming visitor privacy, and provide analytic services for the user that want to know how visitors are behaving in the users' premises.

In another embodiment of the present disclosure, the server system 108 sends location related information of the visitor 102 (processed or unprocessed) to a third party service provider 110, and the third party service provider 110 may send direct advertisement messages to the mobile communication device 104.

FIG. 2 is a schematic illustration of an exemplary sensor 200, which is an example of the sensor 101, in accordance with an embodiment of the present disclosure. The sensor 200 includes a radio interface 202 for receiving radio signals, an I/O interface 204, a Central Processing unit (CPU) 206, a Random Access memory (RAM) 208, and a Read only memory (ROM)/flash 210.

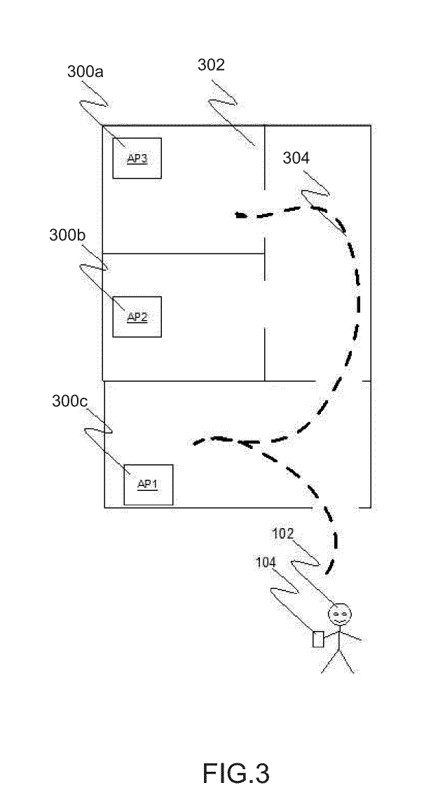

FIG. 3 is an illustration of an exemplary space 302 visited by the user 102 of the mobile communication device 104, in accordance with an embodiment of the present disclosure. The space 302 may be a shopping mall which includes a first wireless access point (AP1) 300a for providing a Wi-Fi connection in a coffee shop, a second wireless access point (AP2) 300b for providing a Wi-Fi connection in a gift shop, and a third access point (AP3) 300c for providing a Wi-Fi connection in a restaurant.

The visitor 102 carries the mobile communication device 104 in which the Wi-Fi capability is turned on. When the visitor 102 enters into the coffee shop to have a coffee, his mobile communication device 104 connects to the wireless network through the AP1 300a, and the SSID and other relevant data of the AP1 300a are added to a list of known networks of the mobile communication device 104. The visitor 102 then leaves the coffee shop and corresponding Wi-Fi connection is terminated. Thereafter, the visitor 102 passes by the second access point (AP2) 300b but does not connect to the wireless network through the AP2 300b. As a result, the AP2 300b is not added to the list of known networks of the mobile communication device 104.

The visitor 102 then goes to the restaurant and connects to the wireless network through the AP3 300b. On connecting to the Internet, the SSID and other relevant data of the AP3 300c are added to the list of known networks in the mobile communication device 104. Thus, as a result of the walking the route 304 in the space 302, the visitor 102 has two new entries in his mobile communication device 104 in the list of known networks.

In practice, the mobile communication device 104 may join several wireless networks, each having a fairly random SSID. In the aforementioned example, the new entries (being character sequences) in the known network list could be, for example “Mike's coffee shop” and “Jane's hamburger joint”. Thus, it is fairly improbable to find two mobile devices that have exactly the same known network list.

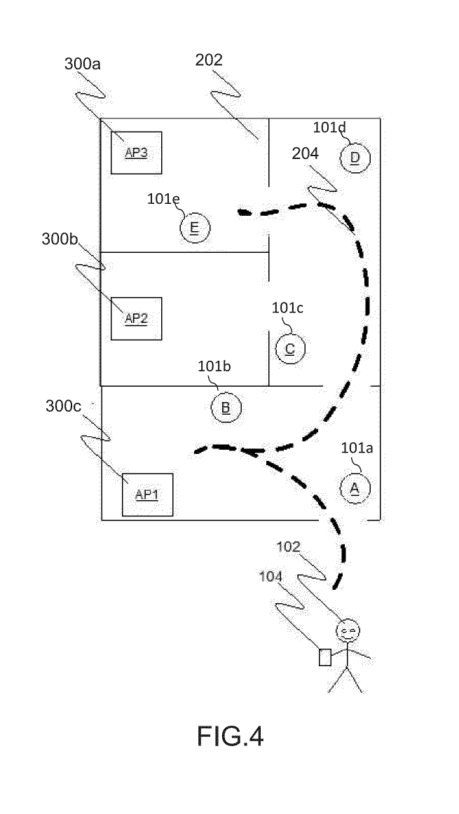

FIG. 4 is an illustration of the exemplary space 202 including the first through fifth sensors 101a till 101e, in accordance with an embodiment of the present disclosure. The space 202 is equipped with a customer tracking system consisting of sensors 101 for sniffing the wireless traffic generated by the mobile communication device 104. Sniffing, in this context, means listening the wireless traffic between the mobile communication device 104 and the AP1, AP2 and AP3 300a, 300b and 300c. For example, when the visitor 102 enters the space 202 with the mobile communication device 104 with the Wi-Fi capability turned on and has both AP1 300b and AP3 300c on the known access point list, the mobile communication device 104 probes the surrounding network by sending Wi-Fi probe messages containing essentially the following information: “I'm MAC address 12:34:56:78:9A:BC, is SSID AP1 available?” “I'm MAC address 12:34:56:78:9A:BC, is SSID AP3 available?”. The Wi-Fi probe requests are typically sent in quick bursts, one request following the other.

The sensors 101 are configured to listen to this wireless traffic but not to reply. Basically, they record the Wi-Fi probe messages and extract essential data, like SSID fields, time stamp etc. and forward the data to the server system 108 as probe packages.

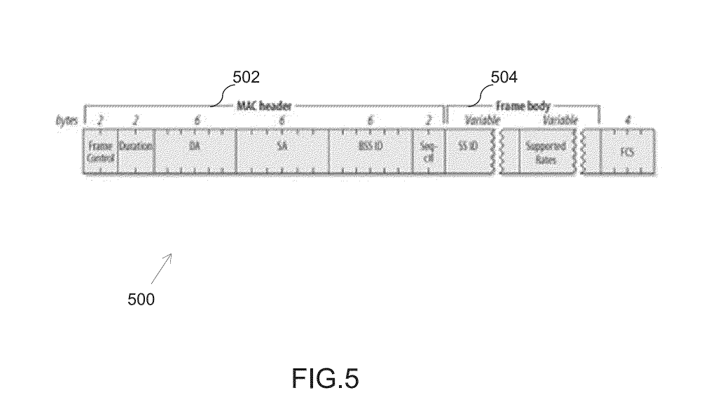

FIG. 5 is an illustration of an exemplary Wi-Fi probe request 500 generated by the mobile communication device 104, in accordance with an embodiment of the present disclosure. The Wi-Fi probe request 500 includes a MAC header field 502 that includes a MAC address of the mobile communication device 104, and a frame body 504 that includes a SSID identifier of a wireless access point.

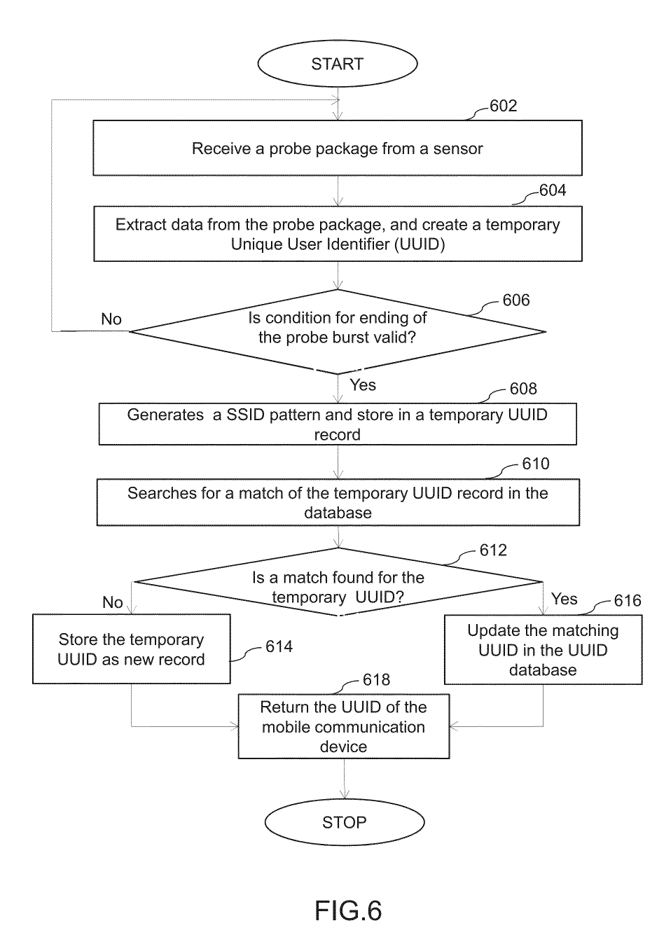

FIG. 6 is an illustration of a method of processing probe packages at the server system 108, in accordance with an embodiment of the present disclsoure.

At step 602, the server system 108 receives a probe package from a sensor 101c, the probe package including a probe request generated by the mobile communication device 104 and other data, like timestamp and sensor ID of the sensor 101c. The probe requests are typically generated by the mobile communication device 104 in a rapid sequence, in form of a burst of messages, each separated by only few tens of milliseconds. A typical probe request includes a mobile device identifier such as a MAC address of the mobile communication device 104, and a network identifier such as SSID of a wireless network.

At a step 604, the server system 108 extracts data such as MAC address of the mobile communication device 104, SSID of the wireless network, and timestamp from the probe request message, and creates a temporary Unique User Identifier (UUID). The UUID is generally formed based on a known network list of the mobile communication device 104 and is fairly unique.

At a step 606, the server system 108 checks if condition for ending of the corresponding probe burst is valid.

If the condition for ending of the probe burst is not valid, then the method returns to the step 602.

If the condition for ending of the probe burst is valid, then at step 608, the server system 108 generates a SSID pattern, associates the SSID pattern with the UUID, and stores both the SSID pattern and the UUID in form of a temporary UUID record. The temporary UUID record represents both the retrieved SSID list (i.e. the list of networks that the mobile communication device 104 has probed) and the known MACs that have been associated with that pattern. The SSID pattern generation may include a preceding filtering process, where one or more SSIDs are omitted from the list of SSIDs of the mobile communication device 104. The SSID pattern is created in such a way that pattern matching algorithms can be well used in identifying patterns that are similar.

At a step 610, the server system 108 searches for a match of the temporary UUID record in a UUID database.

At a step 612, the server system 108 checks whether a match has been found for the temporary UUID record. It should be noted that the list of known networks for the mobile communication device 104 is not constant, and is modified with each new network the device 104 joins in. Therefore, the matching process is not trivial and has to be resolved by methods of pattern matching, like k-NN (k-nearest neighbors), fuzzy logic and so forth.

If a match is not found, then at step 614, the temporary UUID record is stored in the UUID database as a new UUID record.

If a match is found, then at step 616, the server system 108 updates the matching UUID record in the UUID database with temporary UUID record parameters.

Finally at step 618, the server system 108 returns a UUID record of the mobile communication device 104. The UUID record is hereinafter also referred to as a fingerprint of the mobile communication device 104 and is associated with a location of the mobile communication device 104.

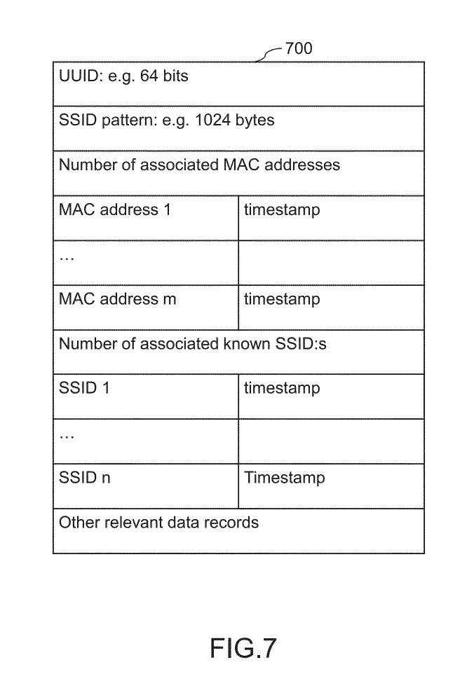

FIG. 7 is an illustration of an exemplary UUID record 700 of the mobile communication device 104, in accordance with an embodiment of the present disclosure. The UUID record 700 includes a UUID of 64 bits, a SSID pattern of 1024 bytes, details of number of associated MAC addresses, and details of number of associated known SSIDs. The SSID pattern field in the UUID record is a reasonably unique and anonymous identifier (i.e. the MAC address of the mobile communication device 104 cannot be deduced from the SSID pattern) that allows tracking of the mobile communication device 104. The UUIDs have no association with actual physical hardware address (MAC) of the mobile communication device 104. It should be also noted that the method is not limited to the mobile communication devices using Wi-Fi networks, but also to devices with other networks, like Bluetooth.

Embodiments of the present disclosure facilitate tracking of movements/location of visitors and providing value added services in top of the location data. The disclosure is specifically applicable when mobile devices randomize the MAC in sending probe requests.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A method for creating an electronic fingerprint for a mobile communication device, comprising:
receiving at a sensor, a first message from the mobile communication device, the first message comprising a mobile device identifier and a network identifier;
sending to the server, a second message that comprises at least a part of the first message, and a sensor identifier;
calculating a first fingerprint from the second message; and
associating the first fingerprint with a first unique identifier.

2. The method of claim 1 further comprising:
comparing similarity level of the first fingerprint and a second fingerprint, the second fingerprint having a second unique identifier stored in the server;
associating the first fingerprint with the second unique identifier if the similarity level of the first fingerprint and the second fingerprint is at least above a predetermined threshold level; and
associating the first fingerprint with the first unique identifier if the similarity level is below the predetermined threshold level.

3. The method of claim 2, wherein the first and second unique identifiers are associated with a location of the mobile communication device.

4. The method of claim 1, wherein the first message includes an IEEE 802.11 based probe request.

5. The method of claim 1, wherein the sensor combines at least two first messages to form the second message.
